(19) United States
(12) Patent Application Publication
(10) Pub. No.: US 2015/0029416 A1
(43) Pub. Date: Jan. 29, 2015

(54) TOUCH SENSOR

(71) Applicant: SAMSUNG ELECTRO-MECHANICS CO., LTD., Gyeonggi-Do (KR)

(72) Inventors: Tae Kyung LEE, Gyeonggi-Do (KR); Beom Seok OH, Gyeonggi-Do (KR); Ho Joo LEE, Gyeonggi-Do (KR); Deok Seok OH, Gyeonggi-Do (KR)

(73) Assignee: SAMSUNG ELECTRO-MECHANICS CO., LTD., Gyeonggi-Do (KR)

(21) Appl. No.: 14/299,860

(22) Filed: Jun. 9, 2014

(30) Foreign Application Priority Data
Jul. 26, 2013 (KR) 10-2013-0089148

(51) Int. Cl. G06F 3/041; G02B 5/23; G02F 1/01

(52) U.S. Cl. CPC G06F 3/0412; G02F 1/0147; G02B 5/23
USPC 349/12; 359/288; 359/241

(57) ABSTRACT

Embodiments of the invention provide a touch sensor, including a window substrate, and bezel layers formed along an outer circumference on the window substrate. The bezel layer includes a photochromic compound or a thermochromic compound expressing at least two colors.

### CROSS REFERENCE TO RELATED APPLICATION

This application claims the benefit of and priority under 35 U.S.C. §119 to Korean Patent Application No. KR 10-2013-0089148, entitled “TOUCH SENSOR,” filed on Jul. 26, 2013, which is hereby incorporated by reference in its entirety into this application.

### BACKGROUND

1. Field of the Invention

The present invention relates to a touch sensor.

2. Description of the Related Art

In accordance with the growth of a computer using a digital technology, devices assisting computers have also been developed, and a personal computer, a portable transmitter, other personal information processors, for example, execute processing of text and graphics using various input devices, such as a keyboard and a mouse.

While the rapid advancement of the information-based society has been increasing the use of computers more and more, it may be difficult to efficiently operate products using only the keyboard and mouse as being currently responsible for the input device function. Therefore, necessity for a device, which is simple, experiences less malfunctions, and is capable of easily inputting information has increased.

Furthermore, current techniques for input devices exceed the level of fulfilling general functions and thus are progressing towards techniques related to high reliability, durability, innovation, designing and manufacturing. To this end, a touch screen has been developed as an input device capable of inputting information such as text and graphics.

The touch sensor is mounted on a display surface of an image display device, such as an electronic organizer, a flat panel display including a liquid crystal display (LCD), a plasma display panel (PDP), an electroluminescence (El) element, as non-limiting examples, or a cathode ray tube (CRT), so that a user selects the information desired while viewing the image display device.

The touch panel is classified into a resistive type, a capacitive type, an electromagnetic type, a surface acoustic wave (SAW) type, and an infrared type. Various types of touch sensor as described above are adapted into an electronic product in consideration of signal amplification problems, resolution differences, the degree of difficulty in designing and manufacturing technology, optical properties, electrical properties, mechanical properties, resistance to the environment, input properties, durability and economic benefits. In particular, resistive and capacitive types are prevalently used at the present time.

As an example of the touch sensors, a structure in which a transparent substrate and a sensing part are adhered to each other using an adhesive as a medium may be provided and a bezel part formed along the edge of the transparent substrate may cover a bus line of the sensing part.

Recently, an exterior design in IT devices becomes increasingly important, and a display screen becomes large. In order to make a display screen large without an increase in an external size of a device and implement full color which is a color close to the real object, the need to narrow an area of the bezel part as compared to the existing bezel part is on the rise.

Korean Patent Application No. 10-2011-0053940 describes a bezel part including a black layer and an indium tin oxide (ITO).

In addition to the recent attempt for implementing various colors to a bezel part of the touch sensor, various efforts to decrease a thickness of a device including a touch sensor have been conducted. In particular, since the bezel part having bright color has an increased thickness in order to decrease transmittance of light, the product also has a thick thickness. Moreover, a bonding problem with a touch panel may occur due to the thin bezel part and since the other bezel parts simply show an aesthetic sense, many difficulties may occur in manufacturing a product capable of satisfying productivity of relevant product or various tastes of users.

### SUMMARY

Accordingly, embodiments of the invention have been made in an effort to provide a touch sensor in which a bezel layer thereof has a color change in two or more colors and with the expression of various colors according to an external stimulation, heat generation or any change according to other external conditions, is capable of being sensed, thereby making it possible to be stably and reliably operated.

According to an embodiment of the invention, there is provided a touch sensor including a window substrate, and bezel layers formed along an outer circumference on the window substrate. The bezel layer includes one of a photochromic compound or a thermochromic compound expressing at least two colors.

According to an embodiment, the photochromic compound includes at least one selected from a group consisting of triarylmethanes, stilbenes, azastilbenes, nitrones, fulgides, spiropyrans, naphthopyrans, spiro-naphthoxazines, and spiro-oxazines.

According to an embodiment, the photochromic compound includes at least one selected from a group consisting of {spiro(2H-2,3-(3H)naphtha(2,1-b)(1,4)oxazine)-1,3-dihydro-1,3,3-trimethyl-6′-(1-piperidinyl)}, {1,3-dihydro-1,3,3-trimethyl-6′-(2,3-dihydro-1H-indole-1-yl)spiro[2H-indole-2,8′-[3H]naphto[2,1-b][1,4]oxazine} and {3,3-diphenyl-3H-naphto(2,1-b)pyran.

According to an embodiment, the bezel layer is formed by mixing the photochromic compound or the thermochromic compound with TiO₂ paste.

According to an embodiment, the bezel layer includes 10 wt % to 70 wt % of the photochromic compound or the thermochromic compound in a paste form, and 30 wt % to 90 wt % of TiO₂ paste.

According to an embodiment, the bezel layer includes 30 wt % to 50 wt % of the photochromic compound or the thermochromic compound in a paste form, and 50 wt % to 70 wt % of TiO₂ paste.

According to an embodiment, the photochromic compound has a color change due to a change in a chemical structure thereof at the time of being exposed to visible light, infrared or ultraviolet light.

According to an embodiment, the thermochromic compound has a color change due to a change in a chemical structure thereof by heat applied from the outside.

According to an embodiment, the thermochromic compound includes at least one selected from a group consisting of spirolactones, fluorans, spiropyrans, fulgides, bisphenol A, parabens, 1,2,3-triazol derivates and 4-hydroxycoumarin.

According to an embodiment, the thermochromic compound includes an electron-donating compound and an electron-accepting compound.

According to an embodiment, the electron-donating compound includes at least one selected from a group consisting of 3,6-dimethoxyfluorane, 3-cyclohexylamino-6-chlorotfluorane, 3-diethylaminobenfraorane, rhodamine B lactone, crystal violet lactone, 3-diethylamino-7-dibenzylaminofluorane and 3-diethylamino-6-methyl-aminofluorane, and the electron-accepting compound may be at least one selected from a group consisting of N-octyl alcohol, N-decyl alcohol, N-lauryl alcohol, N-myristyl alcohol, N-cetyl alcohol and N-stearyl alcohol.

According to an embodiment, the thermochromic compound has a microcapsule shape, the microcapsule having a diameter of 1 μm to 50 μm.

According to an embodiment, the microcapsule has a diameter of 3 μm to 15 μm.

According to an embodiment, the electron-donating compound and the electron-accepting compound are provided in an inner portion of a microcapsule and an outer portion of the microcapsule is covered with a thermosetting resin.

According to an embodiment, the thermosetting resin includes at least one selected from polyester resins, polyurethane resins, melamine resins, epoxy resins, diallyl phthalate resins and vinylester resins.

According to an embodiment, the touch sensor further includes electrode patterns formed between the bezel layers and on the window substrate to recognize touch coordinates of a user; and electrode wires formed on the bezel layer to be electrically connected to the electrode patterns.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a cross-sectional view of a window substrate including a bezel layer according an embodiment of the invention.

FIG. 2 is a cross-sectional view of a touch sensor according an embodiment of the invention.

FIG. 3 is a cross-sectional view of a touch sensor according an embodiment of the invention.

FIG. 4 is a cross-sectional view of a touch sensor according an embodiment of the invention.

FIGS. 5 and 6 are diagrams showing mechanisms in which a thermochromic compound has a color change due to external heat according an embodiment of the invention.

FIG. 7 shows an L*a*b* color space according an embodiment of the invention.

FIG. 8 is a photograph before color of the bezel layer according an embodiment of the invention is changed.

FIG. 9 is a photograph after color of the bezel layer according an embodiment of the invention is changed.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

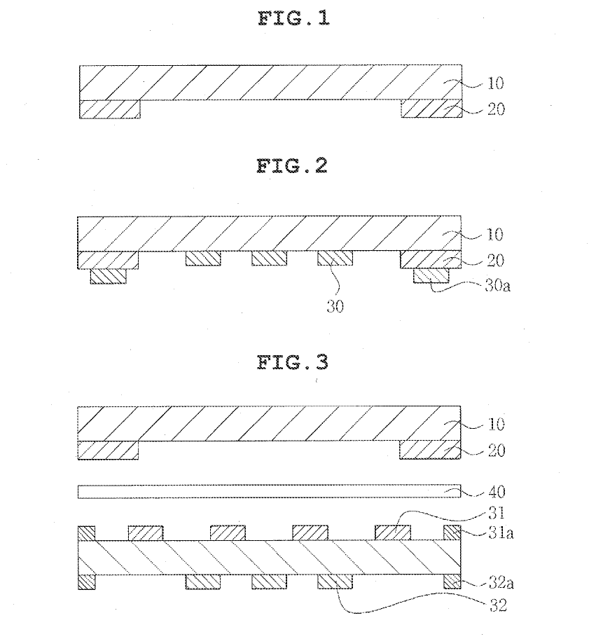

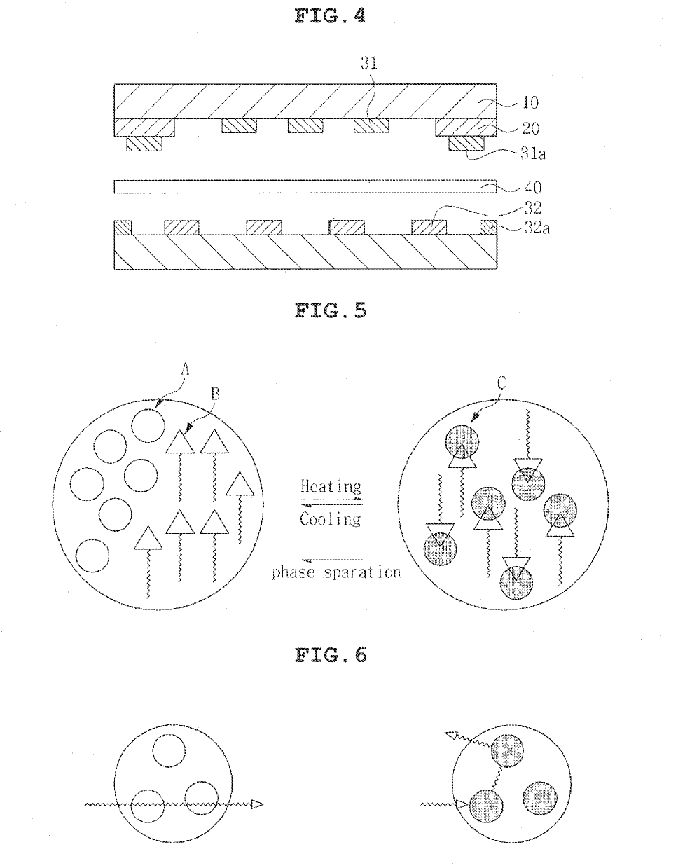

FIG. 1 is a cross-sectional view of a window substrate including a bezel layer according an embodiment of the invention, FIG. 2 is a cross-sectional view of a touch sensor according an embodiment of the invention, FIG. 3 is a cross-sectional view of a touch sensor according an embodiment of the invention, and FIG. 4 is a cross-sectional view of a touch sensor according an embodiment of the invention.

According to an embodiment, the touch sensor according to an embodiment of the invention includes a window substrate 10, and a bezel layer 20 formed along an outer circumference on the window substrate 10. The bezel layer 20 contains one of a photochromic compound or a thermochromic compound expressing at least two colors.

According to an embodiment, the touch sensor is implemented by various structures including the window substrate 10, and is not limited to any specific touch sensor, but may vary without departing from the spirit and scope of the invention.

For example, as shown in FIG. 2, electrode patterns 30 are directly formed on the window substrate 10, which is generally referred to as a window integrated type. The bezel layer 20 is formed along an outer circumference on the window substrate 10 and the electrode pattern 30 is formed in the bezel layer 20 on the window substrate 10. According to an embodiment, the electrode pattern 30 is a single-layered electrode pattern 30 and, as shown in FIG. 4, an intercapacitive-type touch sensor including a first electrode pattern 31 and a second electrode pattern 32 through a separate base substrate 10a is implemented.

In addition, as shown in FIG. 3, in the touch sensor, the first electrode pattern 31 and the second electrode pattern 32 are formed on both surfaces of the base substrate 10a, respectively, and a first electrode wire 31a and a second electrode wire 32a electrically connected to each electrode pattern 30 are formed. In order to protect the first electrode pattern 31 exposed on the base substrate 10a and provide visibility of the first and second electrode wires 31a and 32a, the window substrate 10 having the printed bezel layer 20 is coupled onto the base substrate 10a by a transparent adhesion layer 40.

According to an embodiment, the window substrate 10 or the base substrate 10a is made of the same material as each other. When considering a role of the window substrate 10 as a protective layer, the window substrate is preferably made of reinforcing glass, as a non-limiting example, and a material configuring the base substrate 10a is not specifically limited as long as the material has a predetermined strength and more, but includes, for example, polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass, as non-limiting examples, and is used by performing a primer treatment, for example, for bonding with the electrode patterns 30. Moreover, various materials are selected within a range without blocking visibility of the touch sensor, for example, the base substrate is formed as an insulation layer.

According to an embodiment, the electrode pattern 30 generates a signal by a touch input means to allow a controller (not shown in the drawings) to recognize touch coordinates. The electrode patterns 30 are formed by using copper (Cu), aluminum (Al), gold (Au), silver (Ag), titanium (Ti), palladium (Pd), chromium (Cr), nickel (Ni), or a combination thereof and stacking one or more. Other than those metals described above, the electrode patterns 30, according to at least one embodiment, is made of metal oxide, such as metal silver formed by exposing/developing a silver salt emulsion layer, Indium Thin Oxide (ITO) or using conducting polymer, such as PEDOT/PSS, which is flexible and simply coated. It is obvious to a person skilled in the art that various materials not blocking visibility of the electrode pattern 30 but showing conductivity may be selected and applied.

According to an embodiment, the bezel layer 20 formed on the window substrate 10 contains a photochromic compound or a thermochromic compound capable of changing two or more colors. In particular, a color change of the bezel layer 20 is shown by a predetermined range of heat or light, thereby having a technical feature in which various functionalities are provided.

In particular, in the case of the photochromic compound in which color is changed by light, exposure index, for example, of ultraviolet rays that may be harmful to a person are displayed in various portable devices including the touch sensor to thereby provide an alarm function to a user and implement various colors of the bezel layer 20, thereby adding functional features, as well as effectively performing aesthetic features. In addition, in the case of the thermochromic compound in which color is changed by a transition temperature range, various colors are implemented in a high temperature region or a low temperature region, such that optimization of environment in which a device including the touch sensor is used is measured in real time and heat generation of the device itself including the touch sensor is checked, thereby making it possible to previously prevent risks including damage or an explosion, for example, of a product.

Further, matching heat generation of the electrode pattern 30 by operation of the touch sensor or a change according to indoor and outdoor temperature with a color change provides functional advantages and color implementation of the bezel layer 20 suitable for a surrounding environment improves a product value.

Hereinafter, kinds of the photochromic compound and the thermochromic compound to be added and effects by each material will be described, and each preparation method for effectively performing functions of the bezel layer 20 without blocking operational performance or functions of the touch sensor by applying each material to the touch sensor will be described.

First, according to an embodiment, the photochromic compound changes color thereof by a change in a chemical structure at the time of being exposed to, for example, visible light, infrared rays or ultraviolet rays. In particular, the color of the photochromic compound is changed by ultraviolet rays to provide an alarm function related with external environment of a user, and whether or not there is an exposure to light, color change of the bezel layer 20 is naturally implemented, thereby more effectively changing color of the bezel layer 20 to provide beautiful aesthetic sense. In particular, a controller of the device including the touch sensor is interlinked with an index regarding exposure risk of ultraviolet rays, thereby allowing an external user to recognize color change as an alarm or other vibration functions.

According to an embodiment, the photochromic compound includes at least one selected from a group consisting of triarylmethanes, stilbenes, azastilbenes, nitrones, fulgides, spiropyrans, naphthopyrans, spiro-naphthoxazines, and spiro-oxazines.

Specifically, the photochromic compound includes at least one selected from a group consisting of {spiro(2H-2,3-(3H)naphtha(2,1-b)(1,4)oxazine)-1,3-dihydro-1,3,3-trimethyl-6′-(1-piperidinyl)}, {(1,3-dihydro-1,3,3-trimethyl-6′-(2,3-dihydro-1H-indole-1-yl)spiro[2H-indole-2,8′-[3H]naphto[2,1-b][1,4]oxazine} and {3,3-diphenyl-3H-naphto(2,1-b)pyran.

For example, according to an embodiment, a photochromic compound (CAS number, 114747-45-4) which is photo chromic violet, as a general chemical product name, {spiro(2H-2,3-(3H)naphtha(2,1-b)(1,4)oxazine)-1,3-dihydro-1,3,3-trimethyl-6′-(1-piperidinyl)}″, is discolored as purple color at the time of being irradiated by solar light.

According to an embodiment, photochrome blue having a general chemical product name, {1,3-dihydro-1,3,3-trimethyl-6′-(2,3-dihydro-1H-indole-1-yl)spiro[2h-indole-2,8′-[3H]naphto[2,1-b][1,4]oxazine}, as an example of the photochromic compound, is discolored as blue color at the time of being irradiated by solar light.

According to an embodiment, photochrome yellow having a general chemical product name, {3,3-Diphenyl-3H-naphto(2,1-b)pyran}, as an example of the photochromic compound (CAS number; 4222-20-2), is discolored as yellow color at the time of being irradiated by solar light.

According to an embodiment, it is well known that other colors, for example, red, pink, and orange, as non-limiting examples, show color discolored by light.

Then, the thermochromic compound is a compound capable of implementing various colors according to a range of external temperature. In the case in which the thermochromic compound receives thermal energy to go beyond transition temperature, a molecular structure thereof is changed and an electron-donating compound and an electron-accepting compound are reacted with each other to form a scattering domain. Therefore, incident electromagnetic radiation is reflected at a dispersion region to show reflection property at a specific wavelength band, and thus, color is changed. Before the molecular structure by the above-described reaction is formed, the electromagnetic radiation is transmitted to show transparent color; however, after the dispersion region is formed, color may be expressed through the above-described reflection.

As shown in FIG. 5, the electron-donating compound (A) and the electron-accepting compound (B) are divided into each other and each separately exist, and when heat is applied, the electron-donating compound and the electron-accepting compound are coupled to each other to be changed as a compound (C) having a new structure and thus, the dispersion region is formed to express color. As shown in FIG. 6, before the reaction, the compound has a transparent region directly transmitting light; however, after the reaction, the compound has a region in which light is reflected and dispersed, to thereby implement various colors.

According to an embodiment, the thermochromic compound includes be at least one selected from a group consisting of spirolactones, fluorans, spiropyrans, fulgides, bisphenol A, parabens, 1,2,3-triazol derivates and 4-hydroxycoumarin.

Specifically, the thermochromic compound includes an electron-donating compound and an electron-accepting compound, wherein the electron-donating compound includes at least one selected from a group consisting of 3,6-dimethoxyfluorane, 3-cyclohexylamino-6-chlorofluorane, 3-diethylaminobenfraorane, rhodamine B lactone, crystal violet lactone, 3-diethylamino-7-dibenzylaminofluorane and 3-diethylamino-6-methyl-aminofluorane, and the electron-accepting compound may be at least one selected from a group consisting of N-octyl alcohol, N-decyl alcohol, N-lauryl alcohol, N-myristyl alcohol, N-cetyl alcohol and N-stearyl alcohol.

TABLE 1

| Color | Electron-Donating Compound |
|---|---|
| Yellow | 3,6-dimethoxyfluorane |
| Orange | 3-cyclohexylamino-6-chlorofluorane |
| Red | 3-diethylaminobenfraorane |
| Orange-Red | Rhodamine B lactone |
| Blue | Crystal Violet lactone |
| Green | Diethylamino-7-dibenzylaminofluorane |
| Black | 3-diethylamino-6-methyl-aminofluorane |

TABLE 2

| Alcohol Type | Number of Carbons | Temperature at Color Change |
|---|---|---|
| N-octyl alcohol | 8 | −40° C. |
| N-decyl alcohol | 10 | −13° C. |
| N-lauryl alcohol | 12 | 16° C. |
| N-myristyl alcohol | 14 | 35° C. |
| N-cetyl alcohol | 16 | 45° C. |
| N-stearyl alcohol | 18 | 53° C. |

Table 1 above shows electron-donating compounds, and Table 2 above shows electron-accepting compounds.

As shown in Tables 1 and 2, various colors provided by the electron-donating compounds and each temperature at color change of the electron-accepting compounds coupled to the electron-donating compounds are combined with each other, thereby making it possible to easily implement various temperature ranges and colors.

Referring to Tables 1 and 2, the thermochromic compound causes change in color at a range of −5° C. to 80° C. and an interval of color change may be approximately 3° C.

According to an embodiment, the thermochromic compound is a sensitive material being affected to external environment to thereby have a microcapsule shape capable of providing a function as a protective film for protection. According to an embodiment, the microcapsule includes the electron-donating compound and the electron-accepting compound therein and an outer portion of the microcapsule is covered with a thermosetting resin. Here, the thermosetting resin includes at least one selected from polyester resins, polyurethane resins, melamine resins, epoxy resins, diallyl phthalate resins and vinylester resins. The microcapsule has a diameter of 1 μm to 50 μm, and more preferably, 3 μm to 15 μm.

According to an embodiment, the photochromic compound and the thermochromic compound contained in the bezel layer 20 to be capable of implementing two or more of various colors exist in a transparent state in the case of not satisfying each temperature range regarding light or heat. Therefore, in order to maintain the existing function of the bezel layer 20 and implement color, TiO₂ paste used in implementing a white bezel layer is mixed with the photochromic compound or the thermochromic compound, such that while the white bezel layer 20 is implemented even under external conditions of range in which the photochromic compound or the thermochromic compound is not reacted.

Although titanium oxide, TiO₂, is described as an example in experimental example, any one selected from other aluminum oxide (Al₂O₃), magnesium oxide (MgO), sodium oxide (Na₂O), lithium oxide (Li₂O), beryllium oxide (BeO), silicon oxide (SiO₂), magnesium sulfide (MgS), MgF₂, MgCo₃, ZnO, ZnS, KNO₃, KC, KCl, Ga₂O₃, RbCl, RbF, BaTiO₃, BaSO₄, BaCl₂, as non-limiting examples, or various combinations thereof, are mixed with the photochromic compound or the thermochromic compound, according to at least one embodiment, thereby implementing technically the characteristic features of various embodiments of the invention.

According to an embodiment, the bezel layer 20 is formed by mixing the photochromic compound or the thermochromic compound with TiO₂ paste.

Specifically, the bezel layer 20 includes, for example, 10 wt % to 70 wt % of the photochromic compound or the thermochromic compound in each paste form, and 30 wt % to 90 wt % of titanium oxide (TiO₂) paste, and more preferably, the bezel layer 20 includes, for example, 30 wt % to 50 wt % of the photochromic compound or the thermochromic compound in a paste form, and 50 wt % to 70 wt % of TiO₂ paste.

In the case in which the titanate oxide (TiO₂) paste configuring the bezel layer 20 is mixed with the photochromic compound or the thermochromic compound, when the photochromic compound or the thermochromic compound is contained in 10 wt % or less, a problem occurs in that a discoloration range of the discolored compound may be limited due to an occurrence of white titanate oxide (TiO₂) of the bezel layer 20, and when the photochromic compound or the thermochromic compound is contained in 70 wt % or more, a mixing property with the titanate oxide paste for forming the bezel layer 20 and dispensability may be deteriorated, and at the time of adhering the transparent adhesion layer of the touch sensor, adhesion may be remarkably deteriorated. Therefore, it is appropriate that the bezel composition in a paste form is mixed with the photochromic compound or the thermochromic compound in the above-described range.

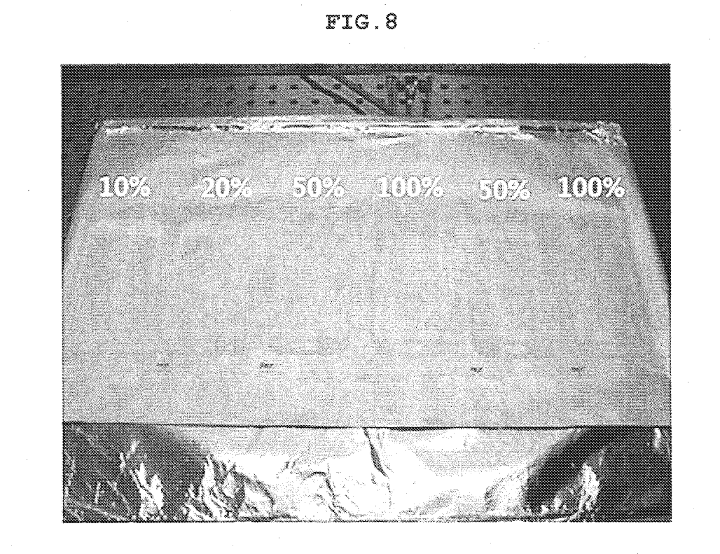

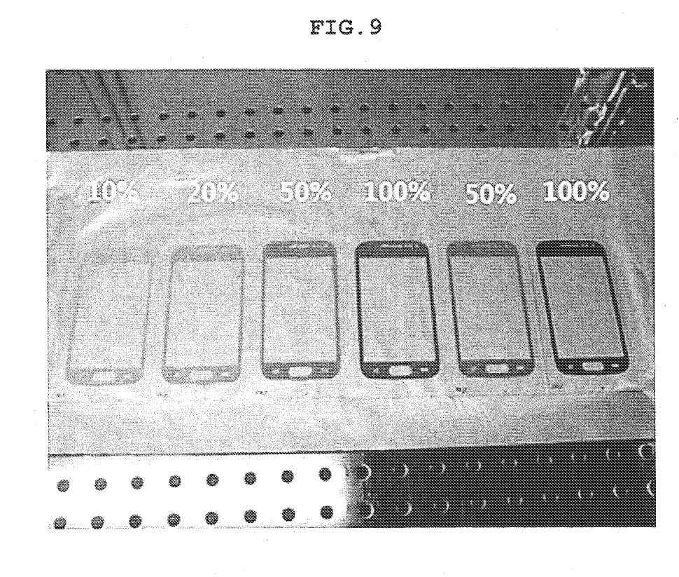

FIGS. 8 and 9 are photograph showing experimental results of color change according to each case in which materials configuring the white bezel of the bezel layer 20 are mixed with the thermochromic compound at a predetermined ratio.

First, in the present experiment, the thermochromic compound of which color is changed at 45° C. was used, and red and blue was provided as representative colors. Each % shown in FIGS. 8 and 9 indicates wt %, and the front numerical value indicates weight % (wt %) relative to the total content of the compound configuring the white bezel and the thermochromic compound.

FIG. 8 shows colors of each bezel layer 20 at a temperature of 45° C. or more in a hot plate. It may be appreciated that the color of the thermochromic compound used in the present experiment is changed at 45° C., and thus, in the other ranges, the compound is transparent and due to the mixed white bezel component, white color is shown.

FIG. 9 shows colors shown in the case in which a transition temperature of the thermochromic compound is satisfied.

TABLE 3

| Content Ratio (Red) | L* | a* | b* |
|---|---|---|---|
| Bezel Composition 95 wt % + Thermochromic | 77.16 | 2.98 | −1.59 |
| Compound 5 wt % | | | |
| Bezel Composition 90 wt % + Thermochromic | 74.32 | 5.27 | −2.28 |
| Compound 10 wt % | | | |
| Bezel Composition 80 wt % + Thermochromic | 71.04 | 7.74 | −2.68 |
| Compound 20 wt % | | | |
| Bezel Composition 50 wt % + Thermochromic | 65.28 | 15.44 | −1.95 |
| Compound 50 wt % | | | |
| Thermochromic Compound 100 wt % | 35.21 | 31.04 | 10.58 |

TABLE 4

| Content Ratio (Blue) | L* | a* | b* |
|---|---|---|---|
| Bezel Composition 50 wt % + Thermochromic | 62.84 | −3.63 | −14.75 |
| Compound 50 wt % | | | |
| Thermochromic Compound 100 wt % | 31.22 | 1.34 | −24.5 |

Table 3 shows a color code according to mixing with the thermochromic compound for a change in red color, and Table 4 shows a color code according to mixing with the thermochromic compound for a change in blue color.

Referring to Tables 3 and 4, and FIG. 9, in the case in which the thermochromic compound is contained at a predetermined ratio or more, the compound is a material, which is similar to rubber, thereby affecting reliability of the touch sensor, including an adhesion problem with a transparent adhesion layer of the touch sensor, and in the case in which the thermochromic compound is contained in an amount less than 10 wt %, a problem that the expressed color itself of the thermochromic compound is not effectively shown by the color of the mixed white bezel occurs. Therefore, at the time of mixing with the white bezel component, the thermochromic compound is preferably contained in a range of at least 10 wt % to 70 wt %, more preferably, 30 wt % to 50 wt %. In this case, as the thermochromic compound, 3-diethylaminobenfraorane was used for expression of the red color and crystal violet lactone was used for expression of the blue color, and N-cetyl alcohol having a transition temperature of 45° C. was used as an electron-accepting compound, and then combined with each other for an experiment.

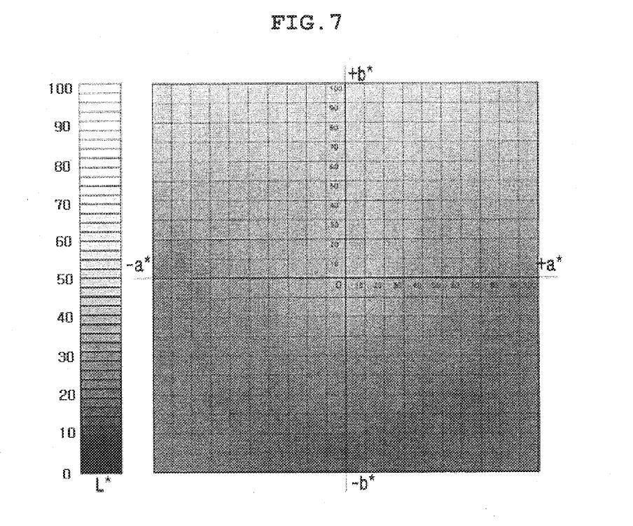

L*, a*, and b* indicate colors in Tables 3 and 4 were made based on a color system of FIG. 7. L*a*b* color system (see FIG. 7) was made to express color errors and small color differences in industrial fields of pigment, paint, paper, plastic, fabric, as non-limiting examples. The color system, which is a result obtained by conducting a study in order to approach human sensitivity, was made based on an opponent-color theory between yellow to blue and green to red capable of being sensed by a human, which is one among color spaces defined by CIE at 1976. In the L*a*b* color system, L* shows brightness, and a* and b* show color directions as shown in coordinates of FIG. 7. That is, +a* indicates a direction in red colors, −a indicates a direction in green colors, +b* indicates a direction in yellow colors and −b* indicates a direction in blue colors. The middle part is a colorless and as a * and b * values are increased, chroma is also increased from the center to the outside. When mixing colors by features of the color system, color errors may be remarkably shown and conversion direction of color may be easily presumed, which is world-widely used.

The above-described results may be applied in the same manner as for the photochromic compound, such that the compound is contained in the bezel layer 20 of the touch sensor, and in order to easily implement various colors, a mixing ratio with the paste composition of the white bezel is adjusted, whereby more optimized color is implemented and negative effects on operation of the touch sensor or reliability is be caused.

According to various embodiments of the invention, the photochromic compound or the thermochromic compound is applied to the bezel layer of the touch sensor, thereby making it possible to implement various colors of the bezel part according to external stimulation.

In addition, the photochromic compound is added to the bezel layer, such that a degree of exposure to ultraviolet rays, for example, in sunlight is sensed to previously prevent risk on skin or other physical hazards due to ultraviolet rays.

Further, the color change of the photochromic compound due to the addition of the photochromic compound and other lights including ultraviolet rays are provided as numerical values and data, and applied to the control processor of the device including the touch sensor, thereby making it possible to perform functions such as alarm, for example, for exposure risk to ultraviolet rays.

In addition, the color change of the photochromic compound and the maintained time of the changed color are adjusted to more effectively prevent the exposure risk to the ultraviolet rays.

Further, the thermochromic compound, according to various embodiments of the invention, is added to the bezel layer, such that in addition to external temperature, risk caused by heat generation, for example, of the touch sensor is previously displayed as a color of the bezel layer, thereby making it possible to prevent risk which may occur to a user of touch sensor and provide more improved reliability related with heat generation of a product.

In addition, with the color change of the thermochromic compound according to a high temperature or a low temperature, the temperature at a specific place as well as indoors or outdoors may be measured and confirmed in real time.

Further, the photochromic compound or the thermochromic compound, according to various embodiments of the invention, has a transparent material by external stimulation having a subcritical value or less, and is mixed with materials having the existing color of the bezel layer, thereby making it possible to provide a stable function capable of shielding the electrode wires, for example, and to implement more various colors of the bezel layer.

In addition, an appropriate temperature range according to colors of the photochromic compound according to various embodiments of the invention, may be adopted and selected, thereby making it possible to perform an alarm function with respect to temperature change to meet appropriate uses in devices applied to various fields in addition to a cell phone including the touch sensor, as a non-limiting example.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner.

Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor comprising:
a window substrate; and
bezel layers formed along an outer circumference on the window substrate,
wherein the bezel layer comprises a photochromic compound or a thermochromic compound expressing at least two colors.

2. The touch sensor according to claim 1, wherein the photochromic compound comprises at least one selected from a group consisting of triarylmethanes, stilbenes, azastilbenes, nitrones, fulgides, spiropyrans, naphthopyrans, spiro-naphthoxazines, and spiro-oxazines.

3. The touch sensor according to claim 1, wherein the photochromic compound comprises at least one selected from a group consisting of {spiro(2H-2,3-(3H)naphtha(2,1-b)(1,4)oxazine)-1,3-dihydro-1,3,3-trimethyl-6′-(1-piperidinyl)}, {(1,3-dihydro-1,3,3-trimethyl-6′-(2,3-dihydro-1H-indole-1-yl)spiro[2H-indole-2,8′-[3H]naphto[2,1-b][1,4]oxazine} and {3,3-diphenyl-3H-naphto(2,1-b)pyran.

4. The touch sensor according to claim 1, wherein the bezel layer is formed by mixing the photochromic compound or the thermochromic compound with TiO₂ paste.

5. The touch sensor according to claim 3, wherein the bezel layer comprises 10 wt % to 70 wt % of the photochromic compound or the thermochromic compound in a paste form and 30 wt % to 90 wt % of TiO₂ paste.

6. The touch sensor according to claim 4, wherein the bezel layer comprises 30 wt % to 50 wt % of the photochromic compound or the thermochromic compound in a paste form, and 50 wt % to 70 wt % of TiO₂ paste.

7. The touch sensor according to claim 1, wherein the photochromic compound has a color change due to a change in a chemical structure thereof at the time of being exposed to visible light, infrared or ultraviolet light.

8. The touch sensor according to claim 1, wherein the thermochromic compound has a color change due to a change in a chemical structure thereof by heat applied from the outside.

9. The touch sensor according to claim 1, wherein the thermochromic compound comprises at least one selected from a group consisting of spirolactones, fluorans, spiropyrans, fulgides, bisphenol A, parabens, 1,2,3-triazol derivates and 4-hydroxycoumarin.

10. The touch sensor according to claim 1, wherein the thermochromic compound comprises an electron-donating compound and an electron-accepting compound.

11. The touch sensor according to claim 10, wherein the electron-donating compound comprises at least one selected from a group consisting of 3,6-dimethoxyfluorane, 3-cyclohexylamino-6-chlorofluorane, 3-diethylaminobenfraorane, rhodamine B lactone, crystal violet lactone, 3-diethylamino-7-dibenzylaminofluorane and 3-diethylamino-6-methyl-aminofluorane, and
the electron-accepting compound comprises at least one selected from a group consisting of N-octyl alcohol, N-decyl alcohol, N-lauryl alcohol, N-myristyl alcohol, N-cetyl alcohol and N-stearyl alcohol.

12. The touch sensor according to claim 1, wherein the thermochromic compound has a microcapsule shape, the microcapsule having a diameter of 1 μm to 50 μm.

13. The touch sensor according to claim 12, wherein the microcapsule has a diameter of 3 μm to 15 μm.

14. The touch sensor according to claim 10, wherein the electron-donating compound and the electron-accepting compound are provided in an inner portion of a microcapsule and an outer portion of the microcapsule is covered with a thermosetting resin.

15. The touch sensor according to claim 14, wherein the thermosetting resin comprises at least one selected from polyester resins, polyurethane resins, melamine resins, epoxy resins, diallyl phthalate resins and vinylester resins.

16. The touch sensor according to claim 1, further comprising:
electrode patterns formed between the bezel layers and formed on the window substrate to recognize touch coordinates of a user; and
electrode wires formed on the bezel layer to be electrically connected to the electrode patterns
